(19) United States
(12) Patent Application Publication
(10) Pub. No.: US 2006/0279054 A1
(43) Pub. Date: Dec. 14, 2006

(54) Transport device and method

(76) Inventors: Chi Dai Chung, Walnut, CA (US); Weihsun Chung, Walnut, CA (US)

Correspondence Address: Larry E. Severin;WANG, HARTMANN GIBBS, PC, 1301 Dove Street, #1050, Newport Beach, CA, 92660, US

(21) Appl. No.: 11/148,809

(22) Filed: Jun. 8, 2005

(51) Int. Cl. B62B 5/00

(52) U.S. Cl. 280/79.11

(57) ABSTRACT

A transport device for transporting an article across a ground surface includes a base pad of flexible material adapted to engage the article on its top surface, and a plurality of platforms joined to the bottom of the base pad. The base pad is flexible enough to fold for storage. Each of the platforms contains a plurality of ball-type casters in its lower surface which roll across the ground surface. Certain platforms also have hooks and loops arranged so that two transport devices can disengagably interlock to form a multiple-device transport system.

### FIELD OF THE INVENTION

This invention pertains to the art of object support apparatus and more particularly to support and transfer apparatus.

### BACKGROUND OF THE INVENTION

In existing luggage, baggage or other article-handling applications, flat, rigid pallets are used to transfer articles from one place to another. Such pallets are typically made from substantially rigid materials, such as plastic, metal, or wood. These materials are rigid or substantially rigid in that, although they can be deformed or broken when exposed to excessive stress or impact, they generally retain their shape, without substantially flexing, bending, or folding under normal use. The pallets are typically designed with a top surface on which the luggage may be sat, and a bottom surface with casters that roll upon the floor or ground so that the luggage may be pushed or pulled from place to place. The casters are typically either wheeled-type, where a disc spins on an axle supported by a swivel frame, or ball-type, where a ball rolls against the ground in any direction. Rigid transfer apparatus include U.S. Pat. No. 3,893,700 to Dunmyer, U.S. Pat. No. 4,060,252 to Mowery and U.S. Pat. No. 6,038,734 to Facchin.

One disadvantage of existing rigid transfer apparatus is that the upper surface, upon which the luggage or article is rested, is made of a large, single piece of inflexible, rigid material, such as plastic. Large pieces of plastic are more difficult to manufacture and handle than smaller pieces. Rigid plastic is more prone to damage than flexible materials. Also, when a large piece of plastic is cracked or suffers significant damage, the entire large piece becomes unusable and must be replaced.

Another disadvantage of existing rigid transfer apparatus is that they can not easily be folded for storage. Rigid pallets are bulky, and can not be stowed in small spaces, such as in the trunk of a small car, or in a handbag. Since rigid pallets cannot be folded or rolled into coils, rigid pallets are not practical for travelers with a limited amount of carrying capability. For example, travelers carrying luggage in airports would find it difficult to stow or carry a plastic pallet, so such travelers are forced to either carry their entire luggage in their arms or rent portable transport carts.

### SUMMARY OF THE INVENTION

It is therefore an object of the invention to provide a transport device having a base pad made from flexible material, which is capable of transporting luggage or other articles across a ground surface.

It is a further object of the invention to provide a transport device that can be folded for storage, so that travelers may carry or stow the invention when not in use, and then unfold the invention to transport luggage in places such as airports.

It is yet a further object of the invention to provide a transport system where two or more transport devices are joined side-by-side or end-to-end to provide a larger top surface, capable of transporting larger articles or multiple pieces of luggage.

In accordance with one aspect of the invention, a transport device for transporting an article across a ground surface comprises a base pad of flexible material on which the luggage sits, such as KEVLAR®, and a number of platforms underneath the base pad having casters to roll against the ground.

In accordance with another aspect of the invention, the platforms can be made from a single piece of plastic, and the casters can be made of steel or other non-compressible balls fixed in retainer cavities in the platforms.

In accordance with another aspect of the invention, two transport devices interlock with each other to form a multiple-device transport system.

In accordance with another aspect of the invention, the transport device has hooks and loops on the short sides of some platforms, so two transport devices can be connected side-to-side, and the platforms at the top and bottom edges of the base pad have hooks and loops on the wide sides so two transport devices can be connected end-to-end.

In accordance with another aspect of the invention, a method of transporting an article across a ground surface comprises providing a transport device as earlier described, lying it on the ground, placing the article upon its upper surface, and rolling the transport device along the ground.

### BRIEF DESCRIPTION OF THE DRAWINGS

The invention is generally shown by way of reference to the accompanying drawings in which:

FIG. 1 illustrates one embodiment of a transport device viewed from underneath;

FIG. 2 illustrates one embodiment of a caster;

FIG. 3 illustrates one embodiment of a transport device in use;

FIG. 4 illustrates one embodiment of a transport device in a stowed position;

FIG. 5 illustrates a side view of one embodiment of a hook on a hooked platform and a loop on a looped platform; and

FIG. 6 illustrates an oblique view of one embodiment of a hook on a hooked platform and a loop on a looped platform.

### DETAILED DESCRIPTION OF THE INVENTION

The preferred embodiment and additional embodiments are described in detail with reference to the related drawings. Further embodiments, features and/or advantages will become apparent from the ensuing description or may be learned by practicing the invention.

In the figures, which are not drawn to scale, like numerals refer to like features throughout the description. The following description of embodiments is not to be taken in a limiting sense, but is made merely for the purposes of describing the general principles of the invention.

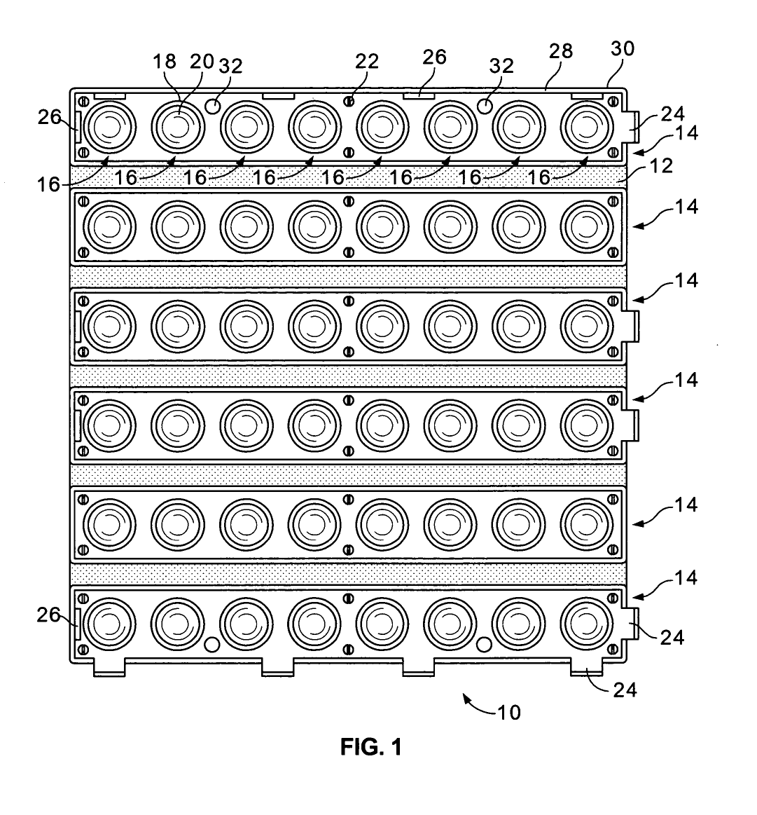

FIG. 1 illustrates one embodiment of transport device 10 viewed from underneath. In one embodiment, transport device 10 includes a base pad 12 and six (6) platforms 14. Each platform 14 contains eight (8) casters 16, where each caster 16 includes a retainer 18 and a ball 20. Base pad 12 is a square measuring eighteen (18) inches on a side. Base pad 12 is made of a high-strength fiber or fabric, such as polyaramid polyparaphenylene terephthalamide, also known as KEVLAR®, so that base pad 12 is strong yet flexible enough to be folded or rolled into a curl when desired. The word “fold” when used herein refers to any bending or reshaping of a flexible object to reduce its length or bulk. An object is “foldable” if it can fold or be folded. The word “flexible” when used herein refers to materials that are not substantially rigid, which includes materials that can change shape, flex, bend or fold under normal use without breaking.

Each platform 14 may be made from a single piece of plastic, such as polycarbonate, so that platforms 14 are strong enough individually to retain casters 16 and strong enough in combination to support the weight of the article being transported. Each platform 14 is individually strong enough to support up to seventy-five (75) pounds of weight without breaking. Each platform 14 is eighteen (18) inches long by two (2) inches high by two (2) inches in width, so that platforms 14 match the width of base pad 12 and leave some space between adjacent platforms 14. Platform 14 is attached to one side of base pad 12 using screws 22, which are inserted through a hole in platform 14 and drilled into the fabric of base pad 12. In other embodiments, platform 14 is attached to base pad 12 using other fasteners or adhesives. Base pad 12, being tightly attached to platform 14, also holds platform 14 in a substantially fixed orientation, to prevent tilting of platform 14 if ball 18 in caster 16 jams. In other embodiments, platform 14 contains three (3) casters 16 equally spaced, so that a caster 16 is near each edge and one caster 16 is near the center.

Certain platforms 14 have hooks 24 extending out past the edges, and loops 26 near the edges which can be utilized to connect two transport devices 10 together. Platform 14 is positioned on base pad 12 so that platform edge 28 is near base pad edge 30, and base pad edge 30 either does not overhang or does not overhang very far past platform edge 28. This allows hook 24 to extend outward from platform 14 and engage with loop 26 of a platform in a second transport device, without interference from base pads 12 of either transport device. Platforms 14 near the top and bottom base pad edges 30 of base pad 12 have hooks 24 and loops 26 at their tops and bottoms, respectively, so that two transport devices 10 may be connected end-to-end. Some platforms 14 have hooks 24 and loops 26 at their sides, so that two transport devices 10 may be connected side-by-side. Some platforms 14 have tie holes 32 that can be utilized to insert rope or string, to be utilized in pulling or stowing transport device 10 or to help tie down the article being transported.

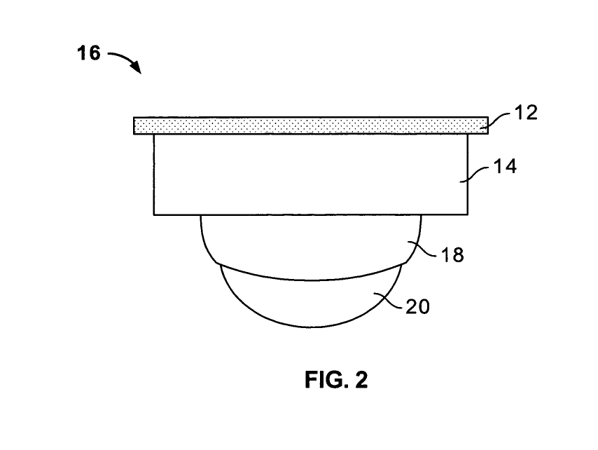

FIG. 2 illustrates one embodiment of caster 16. The word “caster” when used herein refers to wheels or balls with or without an axle, used for support and movement, and is not meant to imply any additional limitation on the claims. In one embodiment, each caster 16 includes retainer 18, which forms a cavity that retains and holds ball 20. Retainer 18 is made by shaping a portion of platform 14, which is cast, formed, or otherwise machined during manufacturing to be an integrated, unitary body of plastic, so that retainer 18 is part of the body of platform 14. Ball 20 is made of a strong, non-compressible material, such as stainless steel. Ball 20 provides omnidirectional rolling engagement with the ground surface, so that it can roll along the ground in any direction. The phrases “ground” and “ground surface” when used herein both mean the solid face or uppermost layer of the body over which the article is to be transported, and may include the tile floor of an airport, the concrete of a sidewalk, dry land, or any place over which wheels or balls could be rolled. At the lower end of caster 16, a portion of ball 20 extends out through an annular opening in retainer 18 so that ball 20 can engage with and roll against the ground, and retainer 18 is restricted in size at the annular opening so that ball 20 will not fall out. In one embodiment, caster 16 includes ball bearings or other bearings in a bearing race (not shown) above ball 20 to reduce friction. For examples of ball-type casters with ball bearings, see U.S. Pat. No. 4,060,252 to Mowery and U.S. Pat. No. 2,779,965 to Schilberg, et al.

In other embodiments, platform 14 is manufactured from one or more pieces of plastic, wood, metal, or ceramic, retainers 18 are manufactured as separate pieces, and each caster 16 is attached to platform 14 during assembly. Balls 20 may be made of plastic, wood, metal, ceramic, or of any resilient, non-compressible material.

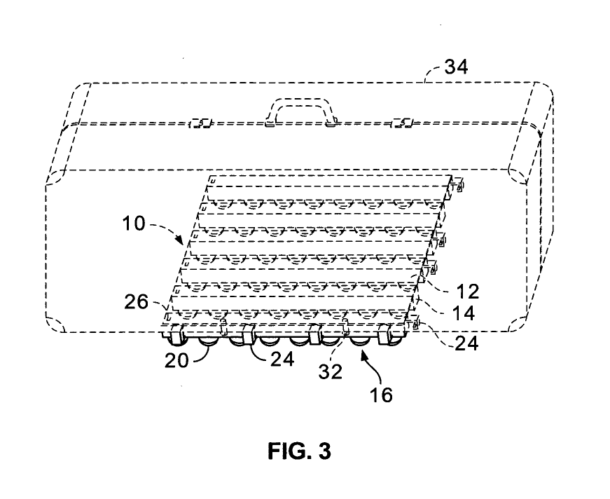

FIG. 3 illustrates one embodiment of transport device 10 in use. In one embodiment, article 34 is a piece of luggage or other item to be transported. When transport device 10 is in use, it is generally laid flat upon the ground, casters down, so that balls 20 in casters 16 are in contact with the ground, and base pad 12 forms a generally planar surface upon which article 34 may be sat or attached. In this position, platforms 14 are in a substantially planar position to each other. Transport device 10 plus article 34 may be pushed along the ground by the operator, or the operator may attach rope (not shown) through holes 32, and use the rope to pull transport device 10 plus article 34 along the ground.

In another embodiment (not shown), transport device 10 includes ties or straps on the upper surface of base pad 12 to tie down or hold article 34. Straps could be bolted or tied to the fabric of base pad 12 or to the plastic of platform 14, or cords or wires could be passed through hole 32.

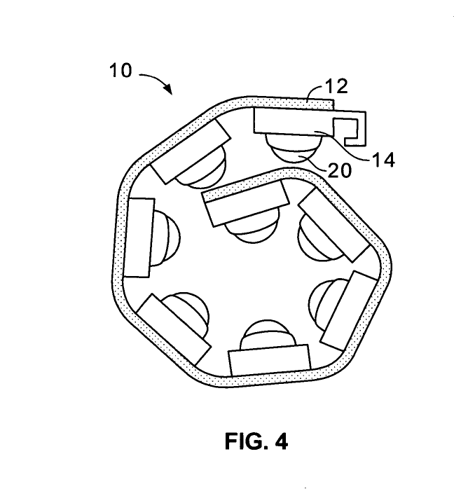

FIG. 4 illustrates one embodiment of transport device 10 in a stowed position. In one embodiment, base pad 12 is flexible enough that it can be folded or rolled into a coil for storage, as depicted in FIG. 4. The embodiment of FIG. 4 has eight (8) platforms 14, which are spaced apart so that there is enough room between them for base pad 12 to be at least partially foldable. In stowed position, base pad 12 is in a substantially non-planar position and platforms 14 are substantially non-planar to each other. Base pad 12 may also be folded in half (not shown), so that one half of base pad 12 lies flat upon the second half of base pad 12, or into thirds or smaller portions, with each portion lying flat upon the portion below it.

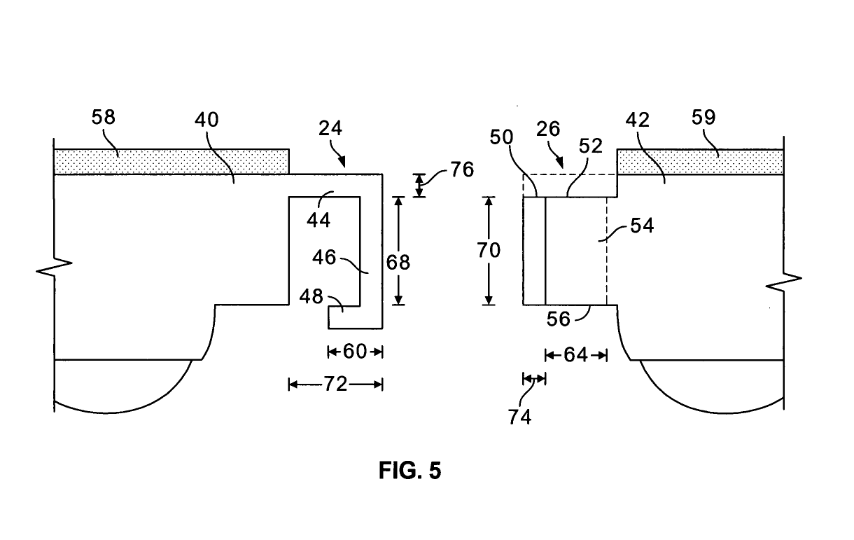

FIG. 5 illustrates a side view of one embodiment of hook 24 on hooked platform 40 and loop 26 on looped platform 42. In one embodiment, hook 24 includes lateral hook element 44 that extends out from hooked platform 40, downward hook element 46 that extends down from the end of lateral element 42, and clasping hook element 48 that extends laterally back toward hooked platform 40. Loop 26 includes depressed region 50 near the edge of looped platform 42, and within depressed region 50, upper loop aperture 52, which leads down through the body of looped platform 42 to form loop chamber 54. Loop chamber 54 is of substantially rectangular shape, and extends through the bottom of looped platform 42 to form lower loop aperture 56.

Hook 24 can engage with loop 26, so that hooked platform 40 can be disengagably interlocked with looped platform 42 to form a multiple-device transport system, which can be utilized to transport heavier or bulkier loads than a single transport device. Hook 24 and loop 26 are shaped so that the clasping elements of hook 24 can pass through and engage with the elements of loop 26, thereby interlocking hooked platform 40 with looped platform 42 in such a manner that base pad 58 of hooked platform 40 is substantially on the same plane as base pad 59 of looped platform 42.

The length of clasping hook element 48 is clasp length 60, and the width is clasp width 62 (not shown in FIG. 5). The length of upper loop aperture 52, loop chamber 54 and lower loop aperture 56 are all chamber length 64, and their widths are all chamber width 66 (not shown in FIG. 5). Chamber length 64 is at least as long as clasp length 60, and chamber width 66 is at least as long as clasp width 62, so that clasping hook element 48 can pass into loop aperture 52, down through loop chamber 54, and emerge from lower loop aperture 56.

The length of downward hook element 46 is downward hook length 68, and the height of the edge of depressed region 50 is loop edge height 70. Downward hook length 68 is at least as long as loop edge height 70, so that upon engaging hook 24 with loop 26, downward hook element 46 passes entirely through loop chamber 54, and clasping hook element 48 completely emerges through lower loop aperture 56. This allows clasping hook element 48 to clasp onto the lower surface of loop 26, so that hooked platform 40 is reliably interlocked with looped platform 42.

The length of lateral hook element 44 is lateral hook length 72, and the distance from the edge of platform 42 to upper loop aperture 52 is loop aperture offset 74. Lateral hook length 72 is at least as long as the sum of loop aperture offset 74 plus clasp length 60, so that lateral hook element 44 is long enough to extend over loop 26, which allows clasping hook element 48 to be inserted into upper loop aperture 52.

The height of lateral hook element 44 is lateral element height 76, which is the same as the depth to which depressed region 50 is below the upper surface of looped platform 42. This allows base pad 58 to align with base pad 59 on the same plane when the platforms are interlocked, thereby producing a substantially planar upper surface for the multiple-device transport system.

In another embodiment, loop 26 is non-rectangular in shape, yet is still of sufficient dimension to receive and engage with hook 24.

In one embodiment, base pad 59 has an edge that ends where depressed region 52 of loop 26 begins, so that loop 26 is exposed. This leaves small gaps in the padded surface of a multiple-device system wherever a platform 42 has a loop 26. In an alternative embodiment, base pad 59 extends out over loop 26 to minimize these gaps. Base pad 59 is loosely connected to platform 42 near loop 26 so that base pad 59 can be lifted slightly to allow insertion of hook 24. In another alternative embodiment, the section of base pad 59 that would lie above loop 26 is cut out or otherwise removed from base pad 59. To fill the small gap this creates in base pad 59, a section of base pad 58 is extended out over hook 24.

In one embodiment, hooks and loops are located on the narrow ends of the platforms. See FIG. 1, where hooks 24 are located on the right sides of some of the platforms 14, and corresponding loops 26 are located on the left sides of the same platforms 14. In FIG. 1, four (4) of the six (6) platforms 14 have hooks and loops on their narrow ends, so that two transport devices can be interlocked side-by-side.

In one embodiment, hooks are located on the lower wide side of one platform at the lower edge of the transport device, and loops are located on the upper wide side of another platform at the upper edge. See FIG. 1, where four (4) hooks 24 are located on the lower wide side of platform 14 at the lower edge of transport device 10, and corresponding loops 26 are located on the upper wide side of platform 14 at the upper edge. Utilizing these hooks and loops, two transport devices can be interlocked end-to-end.

Other embodiments of fastening systems also disengagably interlock two transport devices together in either side-by-side or end-to-end relationships, including interlocking structures such as pins and sockets, hooks and eyelets, cords and loopholes, buttons, snaps, zippers, adhesive, or fabric and hooks such as VELCRO®.

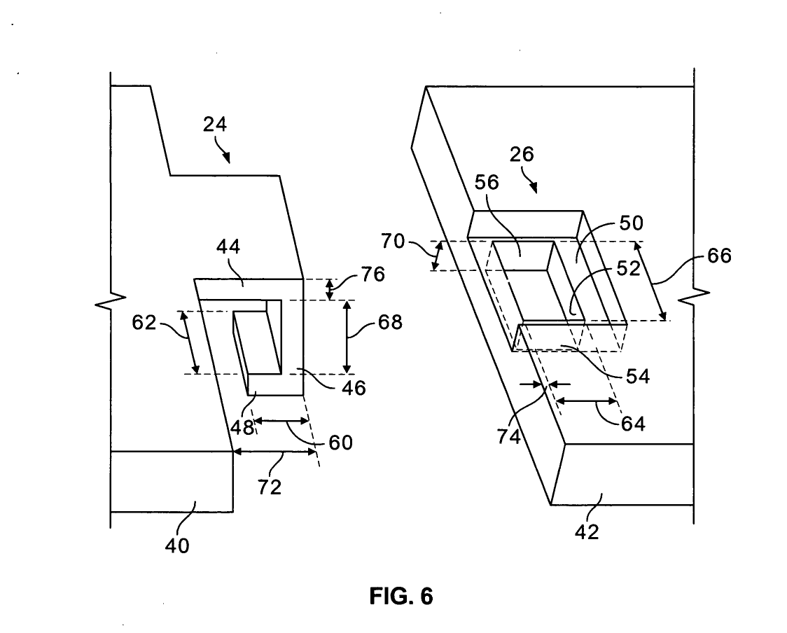

FIG. 6 illustrates an oblique view of one embodiment of hook 24 on hooked platform 40 and loop 26 on looped platform 42. As described in the discussion of FIG. 5, in one embodiment hooked platform 40 includes hook 24, and looped platform 42 includes loop 26. Hook 24 can engage with loop 26, so that hooked platform 40 can be disengagably interlocked with looped platform 42 to form a multiple-device transport system.

In addition to the features shown in FIG. 5, FIG. 6 also shows that the width of clasping hook element 48 is clasp width 62, and the width of upper loop aperture 52, loop chamber 54 and lower loop aperture 56 are all chamber width 66. Chamber width 66 is at least as long as clasp width 62, so that clasping hook element 48 can pass into loop aperture 52, down through loop chamber 54, and emerge from lower loop aperture 56. Base pad 58 and base pad 59 are not shown in FIG. 6.

A person skilled in the art would undoubtedly recognize that other components and/or configurations may be utilized in the above-described embodiments. Moreover, all terms should be interpreted in the broadest possible manner consistent with the context. While the invention has been described in detail with regards to several embodiments, it should be appreciated that various modifications and/or variations may be made in the invention without departing from the scope or spirit of the invention. In this regard it is important to note that practicing the invention is not limited to the applications described hereinabove. Many other applications and/or alterations may be utilized provided that such other applications and/or alterations do not depart from the intended purpose of the invention. Also, features illustrated or described as part of one embodiment can be used in another embodiment to provide yet another embodiment such that the features are not limited to the embodiments described hereinabove. Thus, it is intended that the invention cover all such embodiments and variations as long as such embodiments and variations come within the scope of the claims and their equivalents.

What is claimed is:

1. A transport device for transporting an article across a ground surface, comprising:
a base pad of flexible material, the base pad having a top surface and a bottom surface, the top surface adapted to engage the article;
a plurality of platforms, each platform having an upper surface and a lower surface, the upper surface of each platform joined to the bottom surface of the base pad;
each of the platforms having a plurality of casters disposed on the lower surface of each platform, each caster being adapted to provide rolling engagement with the ground surface; and
the top surface of the base pad is adapted to engage the article and the casters are adapted to engage the ground surface such that the transport device is operable to transport the article across the ground surface.

2. The transport device of claim 1, wherein:
the base pad is flexible enough to be foldable; and
the transport device can be transitioned between an operable position and a stowed position.

3. The transport device of claim 1, wherein each of the plurality of casters comprises:
a retainer forming a cavity such that an annular opening is created; and
a ball of substantially non-compressible material, the ball being fixed in the retainer and freely rotatable relative to the retainer, a portion of the ball protruding outwardly from the retainer through the annular opening so that the ball is adapted to provide omnidirectional rolling engagement with the ground surface.

4. The transport device of claim 3, wherein each platform and the retainers of the casters of said each platform form an integrated, unitary body.

5. The transport device of claim 1, wherein:
the platforms are spaced apart from one another such that portions of the base pad extend between adjacent platforms;
the portions of the base pad extending between adjacent platforms are foldable;
the transport device has an operable position, wherein the platforms are in a substantially planar position to one another; and
the transport device has a stowed position, wherein the portions of the base pad extending between adjacent platforms are folded such that the platforms are in a substantially non-planar position to one another.

6. The transport device of claim 5, wherein the base pad is adapted to fold substantially into the shape of a coil.

7. A transport device for transporting an article across a ground surface, comprising:
a base pad of flexible material, the base pad having a top surface and a bottom surface, the top surface adapted to engage the article;
a plurality of platforms, each platform having an upper surface and a lower surface, the upper surface of each platform joined to the bottom surface of the base pad;
each of the platforms having a plurality of retainers disposed on the lower surface of each platform;
each retainer forming a cavity such that an annular opening is created;
each cavity holding a ball of substantially non-compressible material, the ball being fixed in the retainer and freely rotatable relative to the retainer, a portion of the ball protruding outwardly from the retainer through the annular opening so that the ball is adapted to provide omnidirectional rolling engagement with the ground surface; and
the transport device can be transitioned between a stowed position, wherein the base pad is at least partially folded, and an operable position, wherein the top surface of the base pad engages the article and the casters engage the ground surface such that the transport device is operable to transport the article across the ground surface.

8. The transport device of claim 7, further comprising:
a hook disposed on a first platform;
a loop disposed on a second platform; and
the hook and loop are adapted so that the hook of the transport device is adapted to disengagably interlock with the loop of another transport device.

9. The transport device of claim 7, further comprising:
a hook disposed on a platform;
a loop disposed on said platform; and
the hook and loop are adapted so that the hook of the transport device is adapted to disengagably interlock with the loop of another transport device.

10. The transport device of claim 1, further comprising:
interlocking means for disengagably interlocking two transport devices together.

11. The transport device of claim 10, wherein the interlocking means comprises:
a hook disposed on a first platform of a first transport device;
a loop disposed on a second platform of a second transport device; and
the hook engages with the loop to disengagably interlock the first transport device with the second transport device.

12. The transport device of claim 10, wherein the interlocking means comprises a hook and a loop;
the hook further comprising a lateral element that extends outwardly from transport device, a downward element that extends downwardly from the lateral element, and a clasping element that extends back toward the transport device from the downward element;
the loop further comprising a tab having a downwardly depending aperture, the aperture having an upper and lower opening, the aperture being of sufficient size and dimension to allow the clasping element to enter the upper opening and pass beyond the lower opening, the downward element being of sufficient length and the clasp element being positioned on the downward element so that, upon inserting the hook into the loop, the downward element extends through the aperture so that the clasping element is below the lower opening of the aperture; and
the hook and loop are adapted to join a first transport device to a second transport device by inserting the hook of the first transport device into the loop of the second transport device, thereby disengagably interlocking the first transport device to the second transport device.

13. A transport system comprising:
a first transport device as in claim 1, the first transport device further comprising a first engaging member disposed on at least one platform;
a second transport device as in claim 1, the second transport device further comprising a second engaging member disposed on at least one platform; and
the first engaging member is adapted to disengagably interlock with the second engaging member thereby connecting the first and second transport devices to form a transport system.

14. A method of transporting an article across a ground surface, comprising:
providing a transport device as in claim 1;
lying the transport device on the ground surface so that the casters engage the ground surface;
placing the article upon the upper surface of the transport device so that the base pad engages the article; and
rolling the transport device across the ground surface so as to transport the article across the ground surface.

15. The method of claim 14, further comprising:
folding the base pad into a substantially non-planar position so as to prepare the transport device for storage.

16. The method of claim 14, further comprising:
providing hooks on a platform of a first transport device;
providing loops on a platform of a second transport device; and
disengagably interlocking the hooks with the loops so as to connect the two transport devices to form a transport system.
